(19) United States
(12) Patent Application Publication
(10) Pub. No.: US 2003/0207237 A1
(43) Pub. Date: Nov. 6, 2003

(54) Agent for guiding children in a virtual learning environment

(76) Inventor: Abraham Glezerman, Tel Aviv (IL)

Correspondence Address: DARBY & DARBY P.C., P. O. BOX 5257, NEW YORK, NY, 10150-5257, US

(21) Appl. No.: 10/220,160

(22) PCT Filed: Apr. 3, 2001
(86) PCT No.: PCT/IB01/00557

(51) Int. Cl. G09B 19/00

(52) U.S. Cl. 434/118

(57) ABSTRACT

A method for guiding a young child, “user” (410), in a controlled virtual environment (400) is disclosed. The controlled virtual environment (400) is constructed by software when executed in a computer. A guardian establishes parameters and a user (410) is thereafter presented with the controlled environment which is governed, in part, by the guardian-provided parameters. Data is accumulated concerning interactions and movements of the user's selector device within the controlled environment. The user (410) is provided with guidance on the basis of the accumulated data (415), within the constraints of the parameters provided by the guardian. The guardian can be provided with reports concerning at least a portion of the accumulated data, for example, by electronic mail. The user can select a virtual environment to be displayed in the controlled environment, a visible “buddy” which can be used to provide the aforesaid guidance by communicating to the user, information processed by an intelligent agent software component; and engage in an activity that satisfies constraints or goals provided by the guardian.

### FIELD OF THE INVENTION

The present invention relates to learning and entertainment software, and more particularly concerns a methodology for guiding children and other users within an interactive, virtual learning and playing environment which is defined, in part, by parameters that have been previously provided by a guardian. This invention can further provide guardians with feedback concerning usage of the learning software that the guardian can use to adjust the parameters.

### BACKGROUND OF THE INVENTION

Increasingly, lesson plans for pre-schoolers and kindergartners are being designed to promote learning-oriented activities. Under the guidance of a teacher, for example, a kindergartner's progress can be monitored as he or she plays with materials designed to foster understanding of geometry, measurement, color, size, measurement, estimation, and concepts such as near and far. The National Council for Teachers of Mathematics has released new standards that include guidelines for kindergartners 3-5 years old. Several states including Connecticut and California also have issued guides for teaching pre-schoolers.

As more and more young children use computers (“users”), there is a growing need for controlling and restricting the sites which they can access, and also for guiding and monitoring their activities. There is software available which limits a child's access to inappropriate sites on the Internet, for example, however, such software only provides a barrier to access, and neither guides them nor fosters desired activities or skills nor monitors their actual activities.

As in the real world, very young children require supervision when engaging in activities in public spaces, including virtual spaces such as can be provided through the Internet. The present invention addresses these and other needs.

### SUMMARY OF THE INVENTION

The present invention provides a virtual learning and playing environment in which quality education is imparted to young computer users, such as in the range of 3 to 8 years of age, through a dynamic, interactive multimedia presentation in which the child has apparent control over his or her environment (and can navigate to interactive activities that are of interest to the child), yet in which a guardian has previously provided parameters which govern, in part, the way in which the environment interacts with the child. The present invention enhances this virtual learning environment with tools which guide the child to learning activities that the guardian wishes to encourage, monitors the child's performance, and reports back to the guardian how the child spent his or her time, how well the child performed, as well as other direct, inferred, and derived information. The invention also provides a virtual nanny and instructor embodied as an intelligent agent which better enables a child to venture free of a human escort onto the World Wide Web.

In one aspect, a method for guiding a user in a controlled virtual environment is disclosed. The controlled virtual environment is constructed by software when executed in a computer, personal digital assistant, or other portable digital device. The method includes the steps of obtaining parameters provided by a guardian, presenting a user with the controlled environment along with one or more sets of selectable activities which is governed, in part, by the parameters, and providing guidance to the user within the constraints of the parameters provided by the guardian. The guidance directs the user to predetermined activities in the set of selectable activities.

In another aspect, the invention provides yet another method for guiding a user in a controlled virtual environment is disclosed. The controlled virtual environment is constructed by software when executed in a computer. In this method, parameters are again obtained from a guardian. Also, the user is presented with the controlled environment which is governed, in part, by the parameters. Data is accumulated concerning movements and actions of the user's selector device (e.g., a mouse or joystick) within the controlled environment and perhaps other data input to (e.g., a keyboard or microphone for subsequent speech recognition) or processed by the computer. The user is provided with guidance on the basis of the accumulated data, within the constraints of the parameters provided by the guardian.

In further aspects of the invention, the guardian is provided with reports concerning at least a portion of the accumulated data. The reports can be provided by electronic mail, an instant message, or otherwise. Also, the parameters provided by the guardian can be predefined in a template.

In other aspects of the invention, the user can select a virtual environment to be displayed in the controlled environment. In addition, the user can select an agent to be displayed in the controlled environment which can be used to provide guidance to the user.

In a particularly preferred embodiment, the step of providing guidance to the user includes prompting the user to an activity that satisfies the constraints of the parameters provided by the guardian to foster an activity either in which data already has been accumulated or in which there has been no data accumulated.

In another particularly preferred form, the step of providing guidance to the user includes prompting the user to an activity for which a prize is offered if the user satisfies a goal specified by the guardian. The prize can be paid for by the guardian and preferably relates to an interest of the child (in other words, the prize is something the child likes or wants). In this arrangement, a child user can strive to satisfy a goal presented to him or her in the virtual learning environment without knowing that his or her guardian set that goal or that the guardian is financing the prize. This methodology of clandestinely setting goals and rewards can make the learning experience from interaction with the virtual learning environment appear more spontaneous and magical to young users. Delivery of the prize can be over the Internet if it can be embodied in digital form (e.g., a song, album, celebrity photo, etc.), or can be by conventional mail, courier, or by other delivery mode.

These and other features, aspects, and advantages of the present invention will be apparent from the accompanying Drawing Figures and Detailed Description of a Preferred Embodiment.

### DESCRIPTION OF THE DRAWING FIGURES

FIG. 1 illustrates a network arrangement which can be used to implement a virtual learning environment in accordance with a preferred embodiment;

FIG. 2 illustrates a process flow in which a guardian establishes parameters which govern, in part, the way in which the virtual learning environment interacts with the child;

FIG. 3 illustrates a process flow in which a child interacts with the virtual learning environment and in which dynamic profile data is gathered and reported in accordance with the preferred embodiment; and

FIG. 4 illustrates an exemplary window in which the virtual learning environment can be displayed together with a virtual buddy which provides guidance and suggestions to the child, in accordance with the preferred embodiment.

### DETAILED DESCRIPTION OF A PREFERRED EMBODIMENT

By way of overview and introduction, the invention provides a virtual learning and entertainment environment in which parents, teachers, or other guardians can predefine parameters which govern the manner in which the environment responds to a child user and redefine such parameters from time to time. By referencing prescribed parameters which are tailorable for each child user, the child can be encouraged toward activities that the guardian wishes to foster or in which the guardian wishes the child to develop skills, and can be discouraged from engaging in activities or exclusively engaging in other activities. Thus, beyond conventional filters, the virtual environment of the present invention can foster social skills in a shy child, for example, by encouraging the child to play with other children (whether they are other children connected interacting in the environment from another machine, or whether they are virtual children), and discourage other activities such as incessant playing of shoot-em-up games, or perhaps eliminate certain activities from the environment altogether. The invention therefore provides a degree of parental/teacher involvement in choosing the virtual environment in which their children spend so many hours. The software is both scalable for network use and expandable to include additional functionality and activities. In addition, applications can be added (e.g., downloaded or installed) to suit users of different ages.

Within the controlled virtual environment, there are a plurality of activities from which the user can choose, any of which can provide guidance and education, consistent with parameters provided by the guardian. Consequently, a child user can choose his or her own activity and is therefore more apt to remain interested and motivated to spend time at the computer.

The invention is described in detail with regard to a virtual playground that is made available from a host server connected to the Internet. This is one type of virtual learning environment that can be created through the inventive software. However, the invention applies to many virtual learning environments including, among others, such as preschools, kindergartens, and kitchens. The invention also applies to environments which are established on stand-alone machines, for example, when the software is run locally on the child's machine. Common to all applications, however, is that the environment be content-rich, to provide diverse and stimulating activities including, for example, games, virtual adventures, virtual travel, icon and lettering enriched e-mail, puzzles and the like. The following detailed description, therefore, provides an understanding of one virtual environment in the context of the Internet, but is not limiting of the many environments to which the present invention applies.

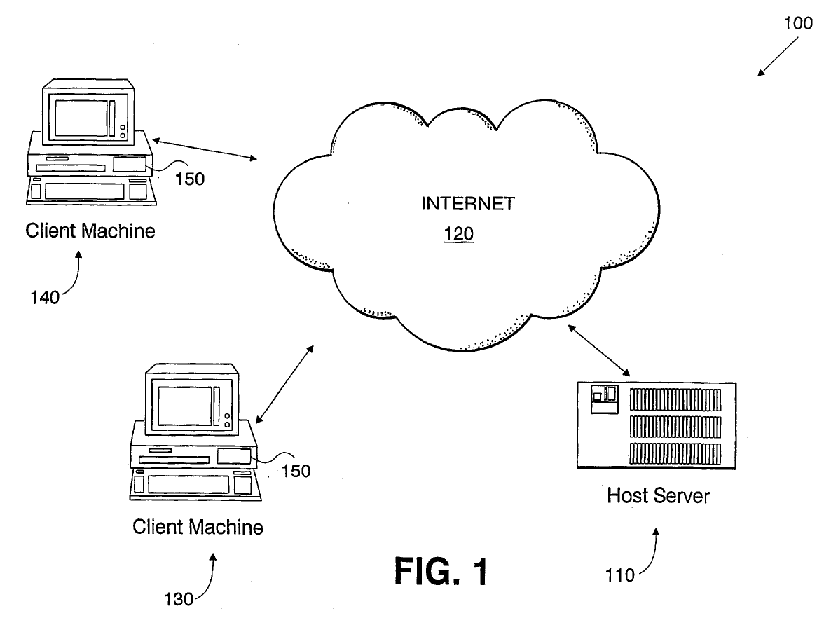

The virtual playground learning environment of the preferred embodiment presents a visual display of a playground on a display of a client machine such as a personal computer, personal digital assistant, or 3G mobile phone. A network arrangement such as shown in FIG. 1 can provide the virtual playground environment to one or more children. The network includes a host server 110 which serves content and Web pages and applets or other active components across a distributed computer network such as the Internet 120 to one or more client machines 130. The communication links between the host server 110, the Internet 120, and the client machines 130 is conventional and forms no part of the present invention.

The virtual playground includes icons with which a child interacts, either one-on-one with the host server, or in a multi-play environment with other children through a distributed computer network such as the Internet, an intranet, or an extranet. The environment presented to the child is governed, in part, by parameters that are obtained from a guardian, for example, one of the child's parents or teachers. The parameters provide a basis for filtering out proscribed activities and encouraging or discouraging prescribed activities, and are established so as to further the guardian's objectives such as to define a safe and fun environment for the child to operate a computer, to define an educational environment to foster learning in one or more areas (math, spelling, etc.), or to define an environment which socialization skills are developed. Preferably, any links made by the child to sites which are not hosted by the host server 110 are displayed within a frame of the active window, thereby providing the child with familiar buttons to use to navigate back to the Web pages delivered by the host server 110.

A. Guardian Parameters

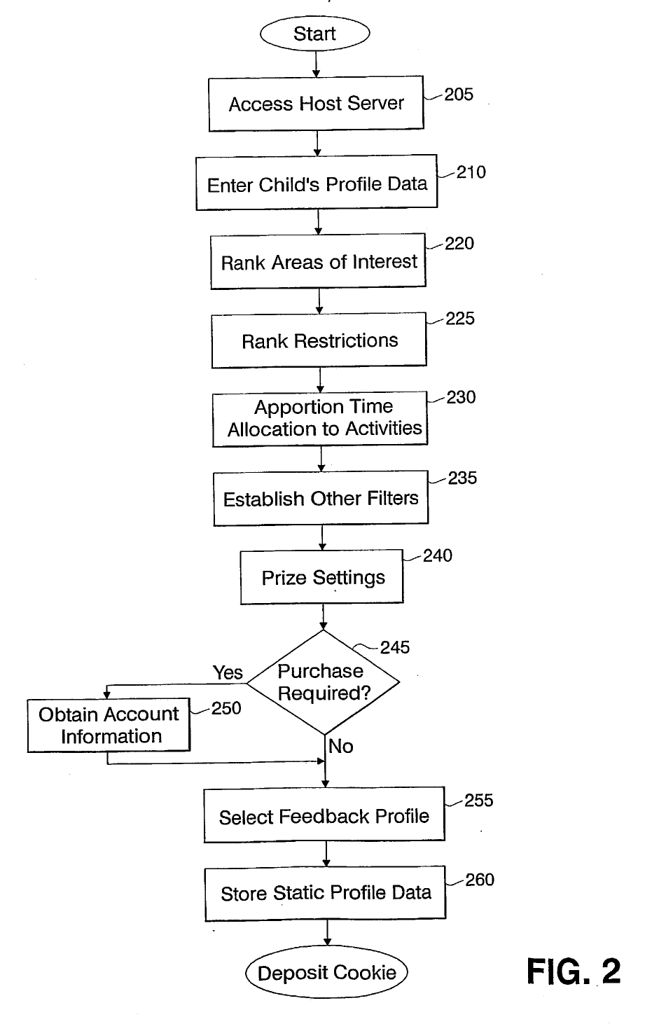

With reference now to FIG. 2, a process flow by which parents or guardians participate in setting the playground parameters for their child is described. At step 205, an authority figure such as a parent, teacher or other guardian (generally referred to herein as “guardian”) accesses the host server 110. The guardian enters child profile data for a particular child, for example, by completing a template or form or by responding to a set or series of questions concerning the child, as indicated at step 210. This child profile data is stored either at the host server 110 or locally at the client machine 140 at which the guardian is situated. The client machine 140 may be identical to the client machine 130 which the child will later use to explore the virtual playground. The benefit of storing the profile data at the host server 110 is that the host server can establish a prescribed environment for the child at any machine connected to the distributed computer network once the user has been identified (e.g., after logging in).

The child's profile data can include the child's name or screen name and an array of familiar components such as his or her favorite hobby and best friend's name, as well as the names of their mother, father, pets, home town, school, and the like. The child profile data can be used to create a sense of familiarity and to tailor the environment to the child so that, for example, an image of a school bears that child's school's name. The child profile data also can be used to offer prizes (games, dolls, toys, music, etc.) that the guardian knows is of interest to the child.

The guardian can set a variety of parameters to influence the child's virtual learning environment. The guardian can set the locale of the environment such as a playground, classroom, church or temple, or “field-trip” environment such as a museum, kitchen, outer space, or other location. Preferably, the child can tailor the environment to a preferred theme, as described below. Also, the guardian can filter out particular games (no shooting games), environments (no swimming pools), characters (no large dogs), stimuli (no images of food), or behavior (no violence in cartoons). The guardian also can schedule educational tasks, require that any scheduled educational task be performed in order to play games, schedule the delivery of messages such as banner ads and other interstitial notices that appear on a display at the client machine between games or activities.

The template can be selected from a list, or a template can be suggested by the host server 110 based on an interview with the guardian and/or the child profile data described above. The interview, for example, can seek the goal that the guardian would like to accomplish (improve child's math skills or social skills, overcome fear of dogs, encourage a physically challenged child to be more at ease with school, etc), and invoke an environment which is appropriate for that goal. The templates can be preprogrammed to invoke environments which are accepted by professionals or standards in certain schools of thought such as a Montessori school format, a specific religious denomination format, and the like in which the elements delivered to the child's client machine 130 will be arranged in accordance with that format. In other words, the Web pages delivered by the host server 110 can be dynamically constructed by selecting and arranging elements stored in a database (e.g., graphics, text, video, hypertext links, applets and other active components, and the like) for display at the client machine in accordance with the requirements of the selected template. Different templates can cause different elements to be extracted from the database and send to the user (e.g., religious symbols or a non-denominational icon). The templates provide a basis for a guardian to establish an at-home alternative or supplement to conventional schools.

The profile for the virtual learning environment can be set in accordance with general guidelines or to a highly detailed learning profile. The parameters can be set manually, or default values can be populated in appropriate forms by selecting a template.

In the preferred embodiment, as indicated at step 220, the guardian can rank educational areas of interest, for example, on a one to ten scale. Preferably, the areas of interest are listed for the guardian and a form is provided for entering a rank. At one end of the scale, an area is filtered out of the virtual environment whereas at the other end of the scale that area is accorded a highest priority level. Thus, for example, Math and Science can be ascribed a “10” if the guardian wishes to foster those educational activities and Spelling can be ascribed a value of “0” if it is to be filtered out altogether. If Geography, Game Play, Social Skills and Creative Play have differing intermediate importance levels to the guardian, then they can be assigned intermediate weights. The relative rankings can then be processed to determine the number, order, and frequency that questions and games in those topic areas are presented to a particular child.

At step 225, the guardian can rank any restrictions on a similar scale using a similar form. Thus, violence, profanity, shoot-em games, and the like can be restricted entirely or to a degree as a function of the rank entered by the guardian. The restrictions can then be processed to determine the degree to which such elements might appear within the questions and games in the selected topic areas.

At step 230, the guardian apportions time among the selected areas of interest and permissible activities. This can be done, for example, on a percentage basis using a standard HTML form. Thus, 35% can be apportioned to educational activities, 35% to fun games with an educational component (e.g., a word or counting game), and 30% to free gaming. The guardian can also restrict certain areas to prescribed time periods (e.g., free gaming only between 6:00 PM and 8:00 PM).

At step 235, the guardian can establish any other filter that may be desired, such as restrictions as to whom e-mail messages can be sent or form whom they can be received, and restrictions as to which links are active or present in the virtual environment to other sites.

At step 240, the guardian sets goals for the child to reach and any prizes or rewards associated with that goal. The goal is preferably an educational target which fosters the child's development in a desired area of interest. For example, the goal can be a challenge to the child—such as an impromptu alert on the child's screen—that the child try and get seven math questions correct. The child can try as many math questions as he or she needs to reach that goal, or can be graded (e.g., must get 7/10 correct to win prize). The prize setting at step 240 can be a video, an animated show, music (e.g., a sound clip from a Britney Spears song) or other feedback which reinforces the child's having reached the goal. The prize also can be selected by the parents as would be any gift for the child (and included in the static profile data), with the prize being automatically purchased on the guardian's account from a vendor affiliated with the hosting Web site when the child reaches a prescribed goal. If a purchase of the prize is required, as tested at step 245, the parent provides account information at step 250 sufficient to permit a credit or debit account of the guardian to be charged. Regardless of the type of prize, the fact that the child reached the goal is preferably reported to the guardian in accordance with reporting preferences and rules that can be set by the guardian, as described next.

At step 255, the guardian selects a feedback profile which governs the frequency, format and nature of the reports that are provided to the guardian of the child's activities in the virtual playground, i.e., the learning environment. The reports are preferably based on data captured by an intelligent agent 150 (discussed below) which is loaded into the client machine 130 and processed in accordance with the settings entered at step 255. The reports can provide an analysis of the child's progress in areas of abstract thinking, memory related exercises, mathematics, vocabulary, and other areas, and can include expert counsel by a real or virtual child psychologist, etc. The guardian can review the report and make changes to the parameters, as desired or as recommended by the psychologist, to reinforce, encourage, discourage, or stem selected activities that its child has undertaken. The report can be pushed to the guardian by e-mail or can be made available at the host server 110 for review by the guardian. The preferred embodiment therefore permits a passive exchange between the guardian and child of what the child did on the computer, with the opportunity for a proactive response from the guardian, if that is deemed necessary. The reports provide the parent with information that can stimulate dialogue with the children in their care which is meaningful and of interest to those children and can detect or assist in detecting previously unknown talents or handicaps (e.g., color blindness).

Each of the selections, rankings and parameters described above in connection with steps 210-255 can be entered by interacting with selection lists, radio buttons, check boxes, and icons as is conventional in graphically driven interfaces such as are supported by the World Wide Web and standard Web browsers such as Microsoft Corporation's Internet Explorer and Netscape's Communicator. Alternatively, default values for these selections can be established initially by a template, with the guardian being permitted to change any of the default entries. The selected parameters will govern, in part, the child's interactions in the virtual space, and will drive the intelligent agent 150, described next. The settings entered by the guardian concerning the child profile data (step 210) and environmental settings (steps 220-240) are stored as “static profile data,” at step 260. The data can be updated, as desired, but is generally static compared to the “dynamic profile data,” discussed below, which is generated in response to the child's actions in the virtual environment. Optionally, the host server 110 can deposit a cookie or similar profile component on the guardian's computer which associates the static profile data with the guardian so that the host server can recognize the guardian the next time the guardian accesses the host server at step 205, for example, to modify the static profile data.

B. Virtual Learning Environment

The virtual learning environment of the preferred embodiment provides activities that the child can select and can provide challenges, contests and pop-up events to promote goals and objectives of the guardian, in accordance with the parameters that have been set by the guardian. The parameters set by the guardian preferably govern the nature, order, and frequency of the actions and events that occur within the environment, while leaving the selection of the actual theme for the environment to the child.

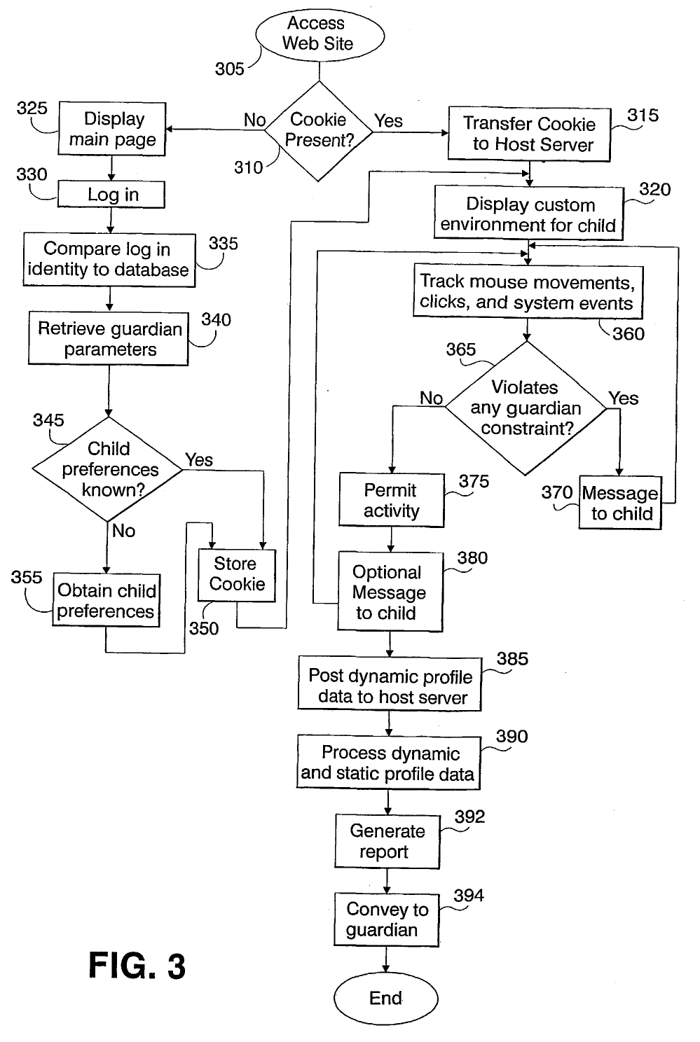

FIG. 3 describes a preferred process flow in which a child's interaction with elements in the playground is influenced by the parameters that were set by the guardian. The child accesses a Web site maintained by the host server 110 in any conventional manner, as indicated at step 305. If there is a cookie present on the client machine 130 that is being used to access the host server, as tested at step 310, then at step 315 the cookie is sent to the host server automatically, as understood by those of skill in the art. The cookie causes a custom virtual environment to be displayed to that child at his or her client machine, as indicated at step 320. As described below, the child preferably can select and change the environment to suit his or her interests or mood.

If no cookie was present, then at step 325 a main page is displayed on the child's client machine 130, and the child is prompted to log into the server, at step 330. The login process is conventional and includes, for example, the child entering his or her name and a password. At step 335, the host server 110 compares the identity of the user who is logging into the system with its database and retrieves, at step 340, the guardian parameters that have been established for that child by his or her guardian if the login identity is located in the database. Otherwise, the user is prompted to login again, as is conventional with password secured services. (If the software runs on a stand-alone machine, there is no need for the child to access a Web site or login. Instead, the guardian parameters are retrieved from the computer.) A test is then made at step 345 to determine whether the child has previously provided his or her preference settings to define a custom virtual environment and a “buddy” selection. If the child has set his or her preference settings, then a cookie is stored on that client machine 130 at step 350 which associates that logged in user with his or her preferences, and the custom virtual environment is presented to the child at step 320, as described above. On the other hand, if that child has not previously selected a “buddy” or playground, then those preferences are obtained at step 355, as described next.

1. The Child's Buddy

When navigating the virtual playground, the child is preferably accompanied by an animated character or buddy which is selected by the child at step 355 and displayed at the client machine 130. The character can be, for example, a licensed toy or cartoon character such as Barbie® or Pokemon®, a professional athlete, musician, singer or celebrity, a historical character such as Beethoven or George Washington, an available fantasy creation or one assembled by the child himself, an animal, or a picture of a person known to the child such as a parent or friend (e.g., provided to the host server 110 while providing other guardian parameters). The child selects a buddy from a list of characters or group of icons in substantially the same manner that other selections were made, as described above, and that selection is obtained at step 355.

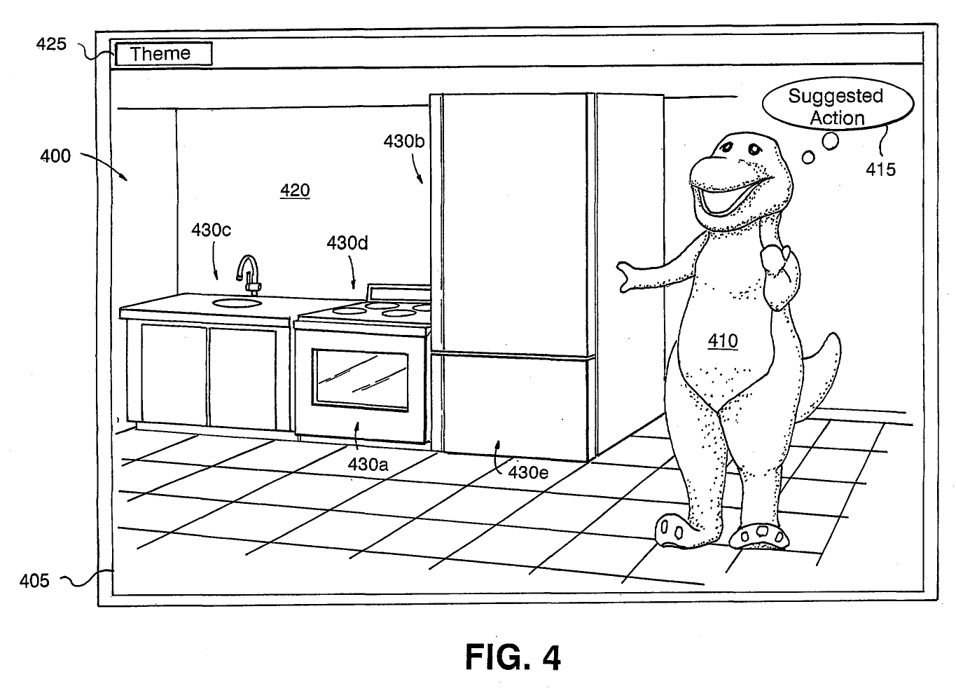

In FIG. 4, a window 405 displayable at the client machine 130 displays the buddy 410 that the child has selected. The buddy 410 preferably communicates with the child in an interactive way such as by speech synthesis from stored text strings, audio files that can be played back through conventional audio players (e.g., the Real player by RealNetworks, Inc., www.real.com), or through balloon messages 415 (as shown).

Superficially, the buddy 410 provides a friendly character which appears within a window or frame and follows and guides the child through various activities. The child is aware of this as he or she interacts with the software. For example, the buddy 410, in its first interaction with the child, can assist the child in establishing a theme 420 and playground components in which the child will play. (Themes are discussed next.) The buddy can be visible throughout the child's session, or can appear intermittently.

However, the child is not aware that the activities and interactive communication with the buddy is within the constraints of parameters that have been provided by the guardian. Neither is the child aware that the buddy conveys information and actions that the intelligent agent 150 has determined are appropriate for the child in view of the parameters provided by the guardian. The intelligent agent 150 operates within the virtual playground to monitor and record the child's inputs, actions and selector (i.e., mouse or joystick) movements, and keyboard or speech inputs as they occur. The agent 150 is discussed below.

2. The Theme of the Virtual Learning Environment

As noted above, the guardian sets parameters which influence the activities and events that the child can experience in a virtual learning environment. These parameters, however, need not necessarily govern how the virtual learning environment appears on the display of the child's client machine 130. Rather, in the preferred embodiment, the child is permitted and encouraged to select a theme 420 for the virtual environment that is to be displayed in the window 405 on his or her machine. The themes 420 that the child can select include, among other examples, outer space, Middle Ages setting, ancient city, playground, game scenarios, suburban back yard, rain forest, sports field or court, living room, kitchen, school yard, library, classroom, museum, music room, art room, a work shop, etc. The theme is selected by the child at step 355, stored either at the host server or at the client machine, and displayed in the window 405 at the client machine, as at step 320. The child can modify and select alternate environments (“where do you want to play today?”) or maintain multiple custom environment from which to select.

The window 405 of FIG. 4, for example, displays a “kitchen” theme 420. The selected theme 420 can be changed by the child at any time, for example, by pressing a theme button 425 which can be displayed as part of the window 405 or in another window or frame. The activities in which the child can engage can be specific to a theme, or can be available regardless of the selected theme. Theme specific activities can include games, questions, and puzzles that relate to the theme. For example, activities specific to the kitchen theme can be designed to foster an understanding of fire, ice, cooking, cleanliness, food groups, health and nutrition. On the other hand, activities that can be generic to any given theme and available to the child regardless of theme selection include answer games, puzzles, brain teasers, vocabulary games, passive and adventure game play, and competitive and non-competitive games.

There is a variety of virtual playgrounds from which the child can select. Each virtual playground includes a theme 420 for the background or environment as well as various components 430 which populate the environment and with which the child interacts as he or she moves about. For example, the virtual playground 400 of FIG. 4 has a kitchen theme 420 and a complement of components including an oven 430a, a refrigerator 430b, a sink 430c, a range 430d, and a freezer 430e. The virtual playground can be preconceived and include both a theme and a selection of components 430, or can be constructed by the child by selecting the theme 420 and the components 430 to include in the virtual playground. The components 430 include, but are not limited to, answer games, puzzles, brain teasers, dress-up games, food games, vocabulary games, racing and action games, shoot-em up games, competitions of any of these or other types of games and activities, and can also include virtual representations of common objects such as shown in FIG. 4 and other objects, whether rendered as a simple graphic image, an anchored image, an interactive image map, a virtual reality model language (VRML) object, flash component, applet, XML object or otherwise.

C. The Intelligent Agent

The intelligent agent 150 is preferably active throughout the child's computer session so as to dynamically generate profile data through the course of the child's interaction with the virtual playground. The nature of the data collected by the agent 150 can vary to meet the objectives of the guardian, and more or less information can be collected depending on the parameters specified by the guardian. Different data can be collected for each logged in child.

Initially, the agent 150 can capture the child preferences that were obtained at step 355 such as the selected buddy 410, theme 420, and components 430, as well as any modifications the child made and how long each setting was in place. During the course of a session at the client machine 130, the agent 150 can also gather basic data on various user inputs such as which games were selected by the child, the games not selected by the child, the amount of time spent at each game, and the child's performance in each game (e.g., percentage of correct questions, ratio of solved to unsolved puzzles, hit to miss ratio in shoot-em games, i.e., coordination and dexterity, etc.), and responses to and interaction with the buddy 410. From this data, the agent can discern which activities the child preferred. Only a subset of this information need be gathered. For example, the data gathered by the agent can be limited to performance data on the child's interaction with tasks that the guardian wanted the child to accomplish.

At a more detailed level, the agent 150 can collect data on the dwell location and time of the mouse, movements of the mouse, mouse clicks, and system events at the client machine such as music, active window size, and the like, as well as the clock at the client machine. This dynamic profile data can be correlated automatically with the content then being provided to the child so as to provide a virtual over-the-shoulder view of what the child was doing at the client machine 130. In this manner, statistical information can be gathered on how long the child took to answer a math problem of a given difficulty level, and aberrant data can be rejected if the mouse were not repositioned or if there is other indicia that the child was not at the machine (or bored) during some of the time that the question was pending. The agent gamers information as to the speed, accuracy, number of times that a game is selected, number of times that an icon is selected, and frequency of interaction with other components 430 (including where the mouse has lingered), and sequence data concerning the child's interaction with these components.

From this data, the agent can discern which components or sounds have improved or detracted from the child's experiences in the virtual playground. For example, a child's response time to questions or puzzles in the presence and absence of background music can be compared to gauge whether the music detracts from the child's ability to concentrate. Likewise, the agent 150 can track differences in response time to gauge the effect on patience or stress during the course of puzzle play by inserting jokes or funny images, and the effect of offering a competitive environment or reward on the child's performance in completing games or challenges (e.g., one child against another, or against a timer, or against the same child's prior timed performance).

Optionally, an input which includes biometric sensors can be used to collect additional data during the course of the child's interaction with the virtual playground. For example, the user's blood pressure or perspiration level/rate can be monitored and provided to the processor at the client machine or host machine for analysis. That user's reaction to various stimuli can be correlated with other data, previously gathered data, or data from other users. For example, one child might be overly excited and perspire when confronted with too many math questions, etc., during a given session, and the biometric information can be provided to the guardian in a report to report or even suggest a reduction in the number of questions or otherwise change the guardian-set parameters.

With continued reference to FIG. 3, the various selector (e.g. mouse or joystick or keyboard) movements, selector inputs (that is, selections of components 430), user inputs, (including speech signals), computer processes, and system events (music, active window size, background color, etc.), are tracked by the intelligent agent, as indicated at step 360. The data gathered by the intelligent agent 150 are preferably used to selectively cause the buddy 410 to communicate messages 415 of suggested actions that the child might take or to communicate other information.

In the event that the child attempts to select or engage in an activity which has been proscribed by the guardian, or in an activity which is not to be performed until other conditions are met, as tested at step 365, then a message 415 is communicated to the child at step 370 and the agent continues to monitor mouse movements and clicks at step 360. The message 415 can be a friendly challenge to the child (“Shall we invite that child to play,” “If you can spell ‘INDIAN,’ I have a reward for you,” etc.), or an instruction that the child must do something else before being permitted to engage in that activity or that the activity cannot be played until a certain time. On the other hand, if the selected activity does not violate any parameters that were set by the guardian, then the activity is permitted at step 375, and the buddy 410 optionally can provide a message to the child such as “This is going to be fun!” All throughout the selected activity, the over-the-shoulder tracking discussed above continues. At the conclusion of the activity, or sooner, the child can select other activities, as indicated by the arrow between step 380 and step 360.

The determinations of whether a guardian-imposed constraint has been violated are made with respect to both static profile data (which includes the guardians rules) and dynamic profile data (which specifies the child's performance or satisfaction of certain conditions such as 10 spelling questions before playing a racing game).

Thus, the agent can influence the child's virtual environment through messages communicated by the buddy 410 or by other means (e.g., simple messages displayed at the client machine) which suggest or initiate activities which comport with the static profile data and other parameters provided by the guardian. Alternatively or in addition, the guardian can participate in the virtual environment 400 in real time along with the user in a multi-play mode.

D. Reports

As noted above, reports can provide an analysis of the child's progress in various areas of thinking, detect talents or handicaps, and can provide raw data as well as statistics on the child's performance in one or more activities, including comparisons to other children of the same age. In addition, the report can include, among other things, a list of all links selected by the child or entered into a Web browser, the addresses to which any e-mails were sent and from which any e-mails were received, and information concerning any chat rooms that were visited or instant messages that were sent.

The dynamic profile data gathered by the intelligent agent 150 preferably includes data representative of the child's talents, achievements, improvements, limitations, rates of improvement, and any biometric data that may have been gathered. This data is posted to the host server 110 at step 385 and is preferably associated with a data record of that child. The dynamic profile data can be posted numerous times during the course of a single session between the client machine 130 and the host server 110. After the session is complete, the static profile data and the dynamic profile data are processed, as indicated at step 390, and a report is generated at step 392. The report is made available to the guardian, for example, in an e-mail message which is conveyed at step 394.

Once the report has been conveyed to the guardian, the guardian can access the host server, as at step 205 described above, and modify the parameters to reinforce, encourage, discourage, or stem selected activities that its child has undertaken. For example, if the child has shown improvement in mathematics to, say, the standard level for a child of that age, the guardian may wish to stress other areas of interest to encourage the child to practice and develop other skills. The report optionally suggests parameter modifications to the guardian which can be approved by, for example, a reply e-mail, with the suggestions established as the new parameters.

The guardian may wish to have a virtual or real expert review the data and have the results of that review included in the report.

A guardian situated at a machine 140 also can be provided with a PIP mirror of what is being provided to the child's machine 130. The dynamic profile data can be used to update the guardian's machine and display what the child is doing.

As noted above, several users can play together in a virtual playground by using different machines that are connected through a network such as the Internet. Each child is preferably presented with an environment which is governed, in part, by parameters that were obtained from their respective guardians. For example, two users can both interact with the same activity provided that the parameters provided by their respective guardians permit access to that activity. Each user preferably has his or her virtual buddy displayed on a display at their respective client machines. Optionally, the virtual buddy of one child can be displayed to the other child. Also, a guardian can interact with a child user, with the guardian's movements within and interactions with the virtual environment optionally being displayed to the child user at the client machine. As a variation, the guardian can assume control over the virtual buddy and interact with a particular user in a real-time mode by conveying messages to the user through the virtual buddy. In accordance with this variation, a teacher can, for example, directly interact with one or more children within the virtual environment.

The examples below illustrate in an exemplary way how the use of the intelligent agent 150 influences the interactions of the child with the virtual learning environment based on parameters provided by the guardian.

### EXAMPLE 1

### No Intelligent Agent

A. A child accesses Web site, a cookie is detected, and that child's buddy and virtual playground are displayed. The Guardian has provided no constraints on the child, set no goals, but has requested reports which indicate how the child elected to spend his or her time.

B. The child selects freely among the games until done playing, and logs off from the host server.

C. The report to the guardian advises what the child did, for how long, and compares that data to statistical data (national, worldwide, etc.).

### EXAMPLE 2

### Active Intelligent Agent Encourages Mathematics

A. As in Example 1, except now the guardian has prescribed as the sole constraint that the child is to be encouraged to practice mathematics.

B. The child selects freely among the games while logged into the host server. During the course of game play and in between games, the child's buddy communicates messages (e.g., through balloons 415) which suggest “Hey, how about we try something really fun?” The child responds “yes” or “no.” A “yes” response means that the child has agreed to follow his or her buddy's suggestion and causes a math-related game, question or puzzle to appear at the client machine. A “no” response means that the child has ignored his or her buddy's suggestion and permits the child to freely choose what to do next or to continue doing what he or she was doing.

C. The report to the guardian advises what the child did, for how long, how often the child followed the suggestion.

### EXAMPLE 3

### Active Intelligent Agent Requires Spelling Exercises

A. As in Example 1, except now the guardian has prescribed as the constraint that the child cannot play any free-play games (e.g., racing or shoot-em games) until 20 spelling questions are answered correctly.

B. The child initially attempts to select a racing game after logging into the host server. The child's buddy communicates a message to encourage the child to try some spelling questions (e.g., “How about a challenge?”). Alternatively, the buddy can specify that the child must answer spelling questions before the racing game can be played. The words to be spelled are audibly produced at the client machine, and the child must enter the letters (e.g., at a keyboard or by using a mouse and a virtual keyboard, or by speech recognition) to spell the word.

C. The report to the guardian advises what the child did or attempted, for how long, and whether the child followed his or her buddy's suggestion, and the child's performance on the spelling questions, if any such data was gathered.

E. In Conclusion

A system and methodology are provided which calls for guardian participation in setting the parameters of a virtual learning and entertainment environment prior to children interacting with that environment, and which provides an intelligent and preferably visible agent to accompany the child through the course of his or her sessions at the client machine. The preferred embodiment generates dynamic profile data on the child's activities in the learning environment and generates reports from that data as well as static profile data on the child which are conveyed to the guardian.

The software can be distributed through the Internet and supported by advertising revenue. Subscription fees also can be collected in exchange for more limited or no advertising, and perhaps more options such as the ability to select a virtual buddy or to permit the child to co-design the virtual environment. The software can include a variety of media including still images, video, audio, and active components such as applets.

The software can provide features of interest to guardians such as chat rooms, bulletin boards, and statistics concerning children of various ages who use the system. Similarly, children can engage in a variety of conventional activities on the World Wide Web while simultaneously being monitored for violations of any constraints that may have been imposed by the guardian.

Those of skill in the art will appreciate that the foregoing processes represent a logical progression of steps which need not be performed in the order illustrated when the program runs in an object-oriented environment such as provided by the World Wide Web. Rather, in such object-oriented environments, process flows are dynamically driven by user input, and the steps can proceed substantially as shown, but in a different order.

The foregoing detailed description concerns a preferred embodiment only. The inventive concept is broader in its contours and can be implemented in a variety of other ways within the spirit of the present invention. The invention is defined by the recitations in the appended claims and equivalents thereof.

We claim:

1. A method for guiding a user in a controlled environment which is constructed by software when executed in a computer, comprising the steps of:
a) obtaining parameters provided by a guardian;
b) presenting a user with the controlled environment which is governed, in part, by the parameters;
c) accumulating user data concerning the user's interactions with and movements within the controlled environment; and
d) providing guidance to the user using the accumulated data within the constraints of the parameters provided by the guardian.

2. The method as in claim 1, including the additional step of reporting to the guardian at least a portion of the accumulated data.

3. The method as in claim 2, wherein the accumulated data reported to the guardian is reported by electronic mail or an instant message.

4. The method as in claim 2, wherein the accumulated data reported to the guardian is stored on a Web server accessible by the guardian.

5. The method as in claim 4, wherein the Web server is only accessible by the guardian after entering a password.

6. The method as in claim 1, wherein the guidance is provided by an intelligent agent software component.

7. The method as in claim 1, wherein the software executing on the digital computer is from one of a CD-ROM and a server connected to a distributed computer network.

8. The method as in claim 1, including the additional step of enabling the user to select a virtual environment to be displayed in the controlled environment.

9. The method as in claim 1, including the additional step of enabling the user to select an agent to be displayed in the controlled environment, the agent providing the guidance to the user.

10. The method as in claim 9, wherein the selection of the agent includes a selection of a virtual environment to be displayed in the controlled environment.

11. The method as in claim 9, including the additional step of enabling the user to select a virtual environment to be displayed in the controlled environment.

12. The method as in claim 1, wherein the data accumulating step comprises tracking the dwell time of a selector operated by the user at a given set of coordinates and movements therefrom to another set of coordinates within the controlled environment.

13. The method as in claim 1, wherein the data accumulating step comprises storing the selections made by the user using a selector within the controlled environment.

14. The method as in claim 1, wherein the step of providing guidance to the user comprises prompting the user to an activity that satisfies the constraints of the parameters provided by the guardian to foster an activity in which data already has been accumulated.

15. The method as in claim 1, wherein the step of providing guidance to the user comprises prompting the user to an activity that satisfies the constraints of the parameters provided by the guardian to foster an activity in which there has been no data accumulated.

16. The method as in claim 1, wherein the step of providing guidance to the user comprises prompting the user to an activity for which a prize is offered if the user satisfies a goal specified by the guardian.

17. The method as in claim 16, wherein the guardian pays for the prize offered to the user.

18. The method as in claim 1, wherein steps (a) through (d) are performed for plural users situated at respective plural client machines interconnected through a computer network, the method including the additional step of displaying a common virtual environment to the plural users at their respective client machines, wherein the accumulating step provides data from a first user at a first client machine to at least a second client machine in the computer network, and wherein the common virtual environment displays the interactions and movements of said first user at least at said second client machine.

19. The method as in claim 18, wherein the accumulation steps provides data from a second user at said second client machine to at least first client machine in the computer network, and wherein the common virtual environment displays the interactions and movements of said second user at least at said first client machine.

20. A method for guiding a user in a controlled environment which is constructed by software when executed in a computer, comprising the steps of:
a) obtaining parameters provided by a guardian;
b) presenting a user with the controlled environment along with a set of selectable activities which is governed, in part, by the parameters; and
c) providing guidance to the user within the constraints of the parameters provided by the guardian, the guidance directing the user to predetermined activities in the set of selectable activities.

21. The method as in claim 20, including the additional step of enabling the user to select a virtual environment to be displayed in the controlled environment.

22. The method as in claim 20, including the additional step of enabling the user to select an agent to be displayed in the controlled environment, the agent providing the guidance to the user.

23. The method as in claim 20, wherein steps (a) through (d) are performed for plural users situated at respective plural client machines interconnected through a computer network, the method including the additional step of displaying a common virtual environment to the plural users at their respective client machines, wherein the accumulating step provides data from a first user at a first client machine to at least a second client machine in the computer network, and wherein the common virtual environment displays the interactions and movements of said first user at least at said second client machine.

24. The method as in claim 23, wherein the accumulation steps provides data from a second user at said second client machine to at least first client machine in the computer network, and wherein the common virtual environment displays the interactions and movements of said second user at least at said first client machine.
